(19) United States
(12) Patent Application Publication
(10) Pub. No.: US 2017/0177147 A1
(43) Pub. Date: Jun. 22, 2017

(54) DISPLAY DEVICE

(71) Applicant: JAPAN DISPLAY INC., MINATO-KU (JP)

(72) Inventors: MICHIAKI SAKAMOTO, TOKYO (JP); KOJI ISHIZAKI, TOKYO (JP); TAKEYUKI TSURUMA, TOKYO (JP)

(73) Assignee: JAPAN DISPLAY INC., MINATO-KU (JP)

(21) Appl. No.: 15/377,264

(22) Filed: Dec. 13, 2016

(30) Foreign Application Priority Data
Dec. 16, 2015 (JP) 2015-244848

(51) Int. Cl. G06F 3/041; G02F 1/1362; G02F 1/1343; G06F 3/044; G02F 1/1333

(52) U.S. Cl. CPC G06F 3/0416; G06F 3/044; G02F 1/13338; G02F 1/134309; G02F 1/136286; G06F 2203/04108; G02F 2201/123; G06F 2203/04112

(57) ABSTRACT

According to one embodiment, a display device comprises pixel electrodes, a drive electrode, a detection electrode, and a detection module. The pixel electrodes are provided for respective pixels arrayed in a display area. The drive electrode forms an electric field for image display with the pixel electrodes. The detection electrode is opposed to the drive electrode. And The detection module detects an object in proximity to the display area based on a signal obtained from the detection electrode. In the display device, the detection electrode includes conductive lines extending parallel to each other, and the conductive lines are arranged at randomized pitch.

### CROSS-REFERENCE TO RELATED APPLICATIONS

This application is based upon and claims the benefit of priority from Japanese Patent Application No. 2015-244848, filed Dec. 16, 2015, the entire contents of which are incorporated herein by reference.

### FIELD

Embodiments described herein relate generally to a display device.

### BACKGROUND

A display device which has the function of detecting an object in proximity to a display area has been in practical use. As an example of a detection method, there is a capacitive detection method in which the proximity of the object is detected based on a change in the capacitance between a detection electrode and a drive electrode facing each other with a dielectric interposed therebetween.

The detection electrode is formed of, for example, conductive lines such as metal lines. If such detection electrodes are arranged in such a manner as to overlap the display area, the conductive lines interfere with pixels included in the display area, and fringes (so-called moiré) may occur.

As a moiré prevention method, for example, a method of randomly distributing intersections of the conductive lines extending at different angles may be adopted. In this method, since there is no regularity of the interference between the conductive lines and the pixels, moiré can be prevented.

However, the pattern of the detection electrodes having randomized intersections will include numerous frequency components. If external light is made incident on a display device comprising such detection electrodes, the reflected light is visually recognized as glare resulting from the detection electrodes, and consequently the display quality will be degraded.

### BRIEF DESCRIPTION OF THE DRAWINGS

FIG. 1 is a schematic plan view showing a structure of a display device according to each embodiment.

FIG. 2 is a schematic view showing an example of a cross-section of the display device.

FIG. 3 is an illustration showing an example of a detection principle of an object in proximity to a display area of the display device.

FIG. 4 is a schematic diagram showing an equivalent circuit for image display of the display device.

FIG. 5 is a plan view showing an example of pixels and a detection electrode of the display device.

FIG. 6 is a plan view showing another example of the detection electrode of the display device.

FIG. 7 is an illustration showing an example of a principle of occurrence of glare.

FIG. 8 is an illustration showing an example of methods for moiré and glare evaluation.

FIG. 9 is an illustration showing a mesh-like detection electrode and an example of glare evaluation of the detection electrode.

FIG. 10 is an illustration showing a detection electrode designed to prevent moiré and an example of glare evaluation of the detection electrode.

FIG. 11 is an illustration showing an example of a pattern of the detection electrode according to a first embodiment.

FIG. 12 is an illustration showing a modified example of the first embodiment.

FIG. 13 is an illustration showing a Fourier pattern obtained from the pattern of the detection electrode shown in FIG. 11.

FIG. 14 is an illustration showing an example of a pattern of the detection electrode according to a second embodiment.

FIG. 15 is an illustration showing a modified example of the second embodiment.

FIG. 16 is an illustration showing an example of a pattern of the detection electrode according to a third embodiment.

FIG. 17 is an illustration showing a modified example of the third embodiment.

### DETAILED DESCRIPTION

In general, according to one embodiment, a display device comprises pixel electrodes, a drive electrode, a detection electrode, and a detection module. The pixel electrodes are provided for respective pixels arrayed in a display area. The drive electrode forms an electric field for image display with the pixel electrodes. The detection electrode is opposed to the drive electrode. And The detection module detects an object in proximity to the display area based on a signal obtained from the detection electrode. In the display device, the detection electrode includes conductive lines extending parallel to each other, and the conductive lines are arranged at randomized pitch.

According to another embodiment, the detection electrode includes conductive lines extending parallel to each other, and slits are provided in random positions in the conductive lines.

According to another embodiment, the detection electrode includes conductive lines extending parallel to each other and dummy patterns arranged in random positions between the conductive lines and electrically unconnected to the conductive lines.

Embodiments will be explained with reference to the accompanying drawings.

Note that the disclosure is presented for the sake of exemplification, and any modification and variation conceived within the scope and spirit of the invention by a person having ordinary skill in the art are naturally encompassed in the scope of invention of the present application. In addition, in some cases, in order to make the description clearer, the drawings may be more schematic than in the actual modes, but they are mere examples, and do not limit the interpretation of the present invention. In each drawing, like or similar elements disposed sequentially may not be denoted by reference numbers or symbols. In the specification and drawings, components that fulfill same or similar functions are denoted by the same reference number and their overlapping descriptions may be omitted.

As an example of a display device and a touch detection device, a display device having the function of displaying an image using a liquid crystal display element and the function of touch detection will be described in the embodiments. However, the embodiments do not preclude the application of individual technical ideas disclosed in the embodiments to display devices using display elements other than the liquid crystal display element. As the display devices, for example, a self-luminous display device comprising an organic electroluminescent display element, or an electronic-paper type display device comprising a cataphoretic element may be considered. The touch detection device may be independent of the display device and attached to the display device.

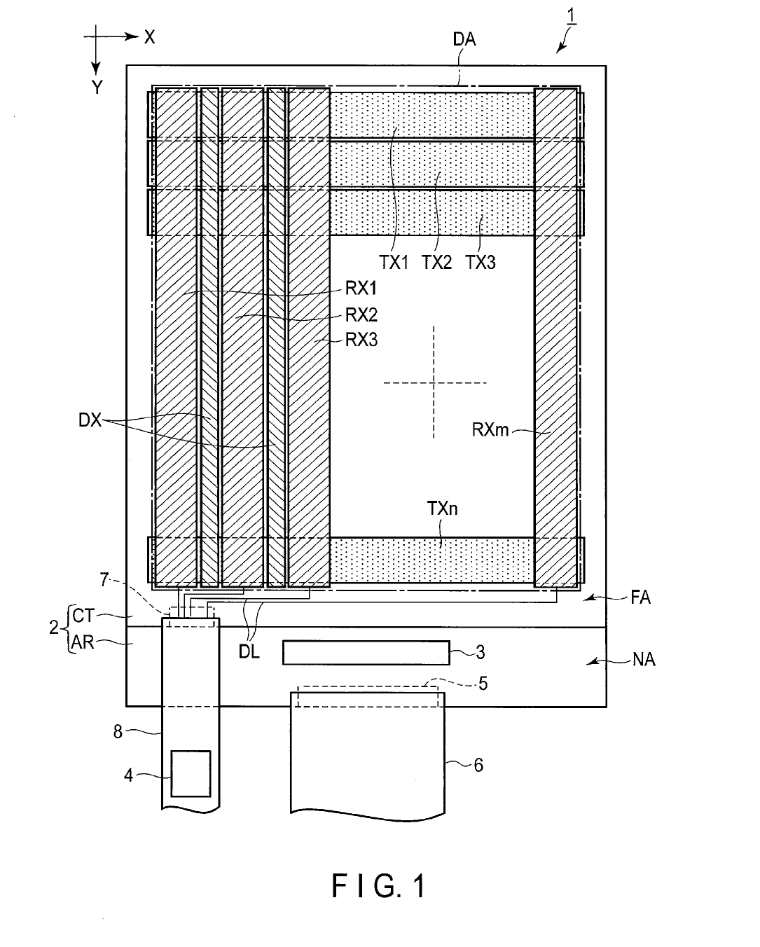

First, the structure common to the embodiments to be described later will be described with reference to FIG. 1 to FIG. 10. FIG. 1 is a schematic plan view showing a structure of a display device 1 according to each embodiment. The display device 1 can be used for various devices such as a smartphone, a tablet, a mobile phone, a personal computer, a television receiver, a vehicle-mounted device, a game console and the like.

The display device 1 comprises a display panel 2, drive electrodes TX (TX1 to TXn), detection electrodes RX (RX1 to RXm) opposed to the drive electrodes TX, a driver IC 3 serving as a driver module, and a touch detection IC 4 serving as a detection module. For example, n and m are integers not less than two. The drive electrodes may also be referred to as common electrodes.

The display panel 2 comprises a rectangular array substrate AR (first substrate) and a rectangular counter-substrate CT (second substrate) smaller in outer shape than the array substrate AR. In the example of FIG. 1, the array substrate AR and the counter-substrate CT are attached to each other such that three sides of one substrate are laid on three sides of the other substrate. The array substrate AR comprises a terminal area NA (unopposed area) not opposed to the counter-substrate CT.

In an area where the array substrate AR and the counter-substrate CT are opposed, the display panel 2 comprises a display area (active area) DA where an image is displayed and a peripheral area FA between the display area DA and the end of the display panel 2. In the example of FIG. 1, the display area DA is a rectangular area having short sides extending in the first direction X and long sides extending in the second direction Y. The first direction X and the second direction Y are orthogonal to each other in the embodiments, but may cross each other at another angle.

In the display area DA, the drive electrodes TX1 to TXn extend in the first direction X and are arranged in the second direction Y. The drive electrodes TX1 to TXn can be formed of a transparent conductive film of, for example, indium tin oxide (ITO). For example, the drive electrodes TX1 to TXn are formed inside the display panel 2, i.e., in the array substrate AR. In the display area DA, the detection electrodes RX1 to RXm extend in the second direction Y and are arranged in the first direction X. For example, the detection electrodes RX1 to RXm are formed on a surface of the counter-substrate CT, which is opposite to a surface opposed to the array substrate AR. The drive electrodes TX1 to TXn may extend in the second direction Y and be arranged in the first direction X and the detection electrodes RX1 to RXm may extend in the first direction X and be arranged in the second direction Y.

The driver IC 3 executes control related to image display, and is mounted in the terminal area NA. In the terminal area NA, a mounting terminal 5 is formed. A first flexible printed circuit 6 which supplies image data to the display panel 2 is connected to the mounting terminal 5.

A mounting terminal 7 is formed at an end of the counter-substrate CT along the terminal area NA. A second flexible printed circuit 8 which outputs detection signals from the detection electrodes RX1 to RXm is connected to the mounting terminal 7. In the example of FIG. 1, the touch detection IC 4 is mounted on the second flexible printed circuit 8. For example, the detection electrodes RX1 to RXm are connected to the mounting terminal 7 via detection lines DL formed on the surface of the counter-substrate CT in the peripheral area FA.

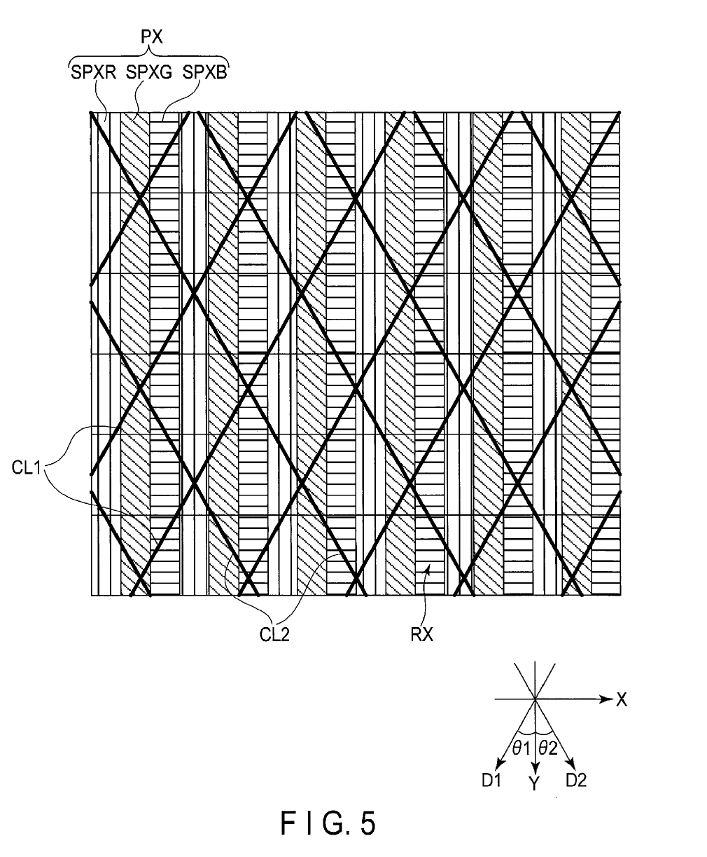

In the example of FIG. 1, a dummy electrode DX is formed between two adjacent detection electrodes RX. The dummy electrodes DX are not connected to the detection lines DL and are electrically floating. The dummy electrodes DX do not contribute to touch detection, but have a function of preventing optical unevenness between a portion of the display area DA provided with the detection electrode RX and a portion of the display area DA not provided with the detection electrode RX. The detection electrodes RX1 to RXm and the dummy electrodes DX are illustrated as strip-shaped elements in FIG. 1 for simplicity, but as will be described later with reference to FIG. 5, the detection electrodes RX1 to RXm and the dummy electrodes DX are formed of conductive lines, more specifically, metal lines.

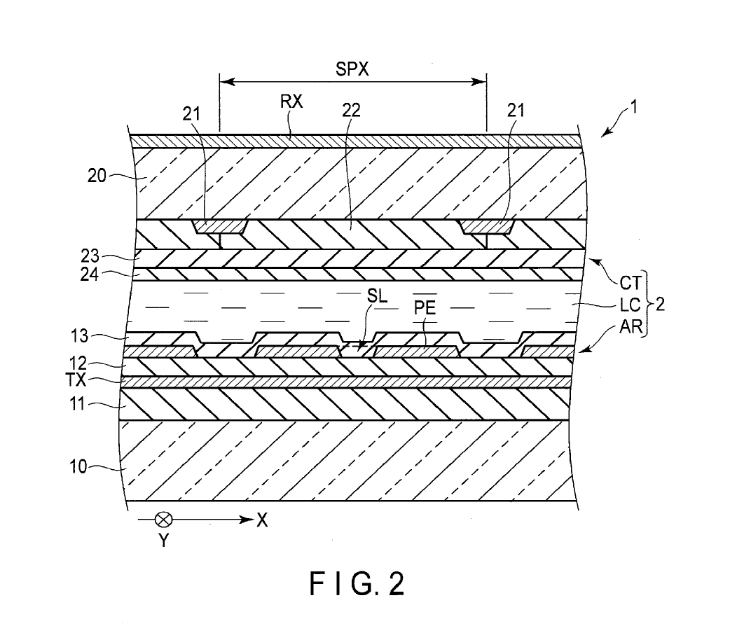

FIG. 2 is a schematic view showing an example of a cross-section of the display device 1 in the display area DA. The cross-section shown in FIG. 2 focuses on one sub-pixel SPX. Sub-pixels SPX corresponding to different colors form one pixel for displaying a color image.

In the example of FIG. 2, the array substrate AR comprises a first insulating substrate 10, a first insulating layer 11, a second insulating layer 12, a first alignment film 13, pixel electrodes PE and drive electrodes TX. The first insulating layer 11 is formed on a surface of the first insulating substrate 10 on the counter-substrate CT side. The drive electrodes TX are formed on the first insulating layer 11. The second insulating layer 12 covers the drive electrodes TX. The pixel electrodes PE are provided for the respective sub-pixels SPX and are formed on the second insulating layer 12. For example, each pixel electrode PE comprises one or more slits SL. The first alignment film 13 covers the pixel electrodes PE and part of the second insulating layer 12.

The counter-substrate CT comprises a second insulating substrate 20 as a transparent substrate, a light-shielding layer 21, color filters 22, an overcoat layer 23 and a second alignment film 24. The light-shielding layer 21 is formed on a surface of the second insulating substrate 20 on the array substrate AR side to define the sub-pixels SPX. The color filters 22 are formed on the surface of the second insulating substrate 20 on the array substrate AR side and colors corresponding to the sub-pixels SPX are applied to the color filters 22. The overcoat layer 23 covers the color filters 22. The second alignment film 24 covers the overcoat layer 23.

A liquid crystal layer LC including liquid crystal molecules is formed between the first alignment film 13 and the second alignment film 24. The detection electrodes RX are formed on a surface of the second insulating substrate 20 which is not opposed to the array substrate AR. The dummy electrodes DX are also formed on the surface of the second insulating substrate 20 which is not opposed to the array substrate AR. The drive electrodes TX are formed in the array substrate AR in the example of FIG. 2, but may be formed in the counter-substrate CT. The internal structure of the display panel 2 is not limited to those disclosed herein, and various structures can be applied.

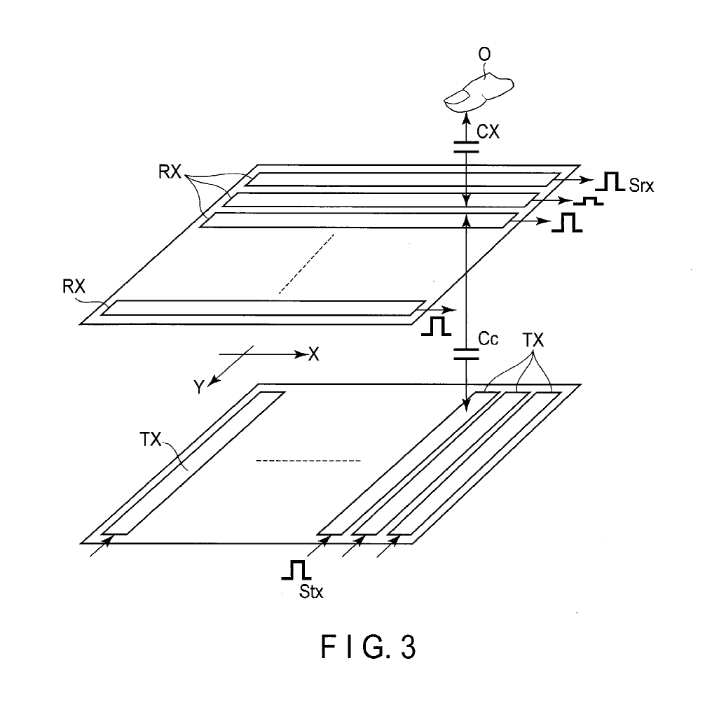

Next, an example of the principle of detection of an object in proximity to the display area DA by the drive electrodes TX and the detection electrodes RX will be described with reference to FIG. 3.

Capacitance Cc exists between the drive electrode TX and the detection electrode RX which are opposed to each other. When a drive signal Stx is supplied to the drive electrodes TX, a current flows through the detection electrodes RX via the capacitance Cc, and thus, a detection signal Srx is obtained from each detection electrode RX.

When an object O, which is a conductor such as a user's finger, approaches the display device 1, capacitance Cx is produced between the object O and a detection electrode RX in proximity to the object O. When the drive signal Stx is supplied to the drive electrodes TX, a waveform of a detection signal Srx obtained from the detection electrode RX in proximity to the object O changes under the influence of the capacitance Cx. That is, the touch detection IC 4 can detect the object O in proximity to the display device 1 based on the detection signal Srx obtained from each detection electrode RX. The touch detection IC 4 can also detect a position of the object O in the first direction X and the second direction Y, based on the detection signal Srx obtained from each detection electrode RX in each time phase when the drive signal Stx is sequentially supplied to the drive electrodes TX in a time-division manner. The above-described method is referred to as a mutual-capacitive method, a mutual-detection method or the like.

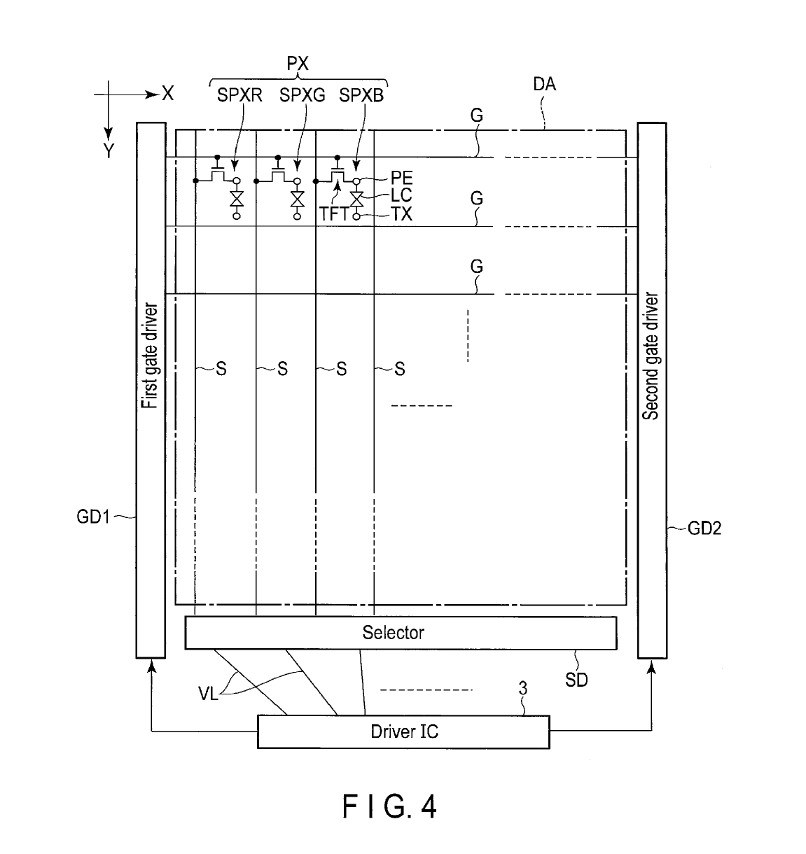

Next, image display by the display device 1 will be described. FIG. 4 is a schematic diagram showing an equivalent circuit for image display. The display device 1 comprises scan lines G, signal lines S crossing the scan lines G, a first gate driver GD1, a second gate driver GD2 and a selector (an RGB switch) SD. The selector SD is connected to the driver IC 3 via video lines VL.

The scan lines G extend in the first direction X and are arranged in the second direction Y in the display area DA. The signal lines S extend in the second direction Y and are arranged in the first direction X in the display area DA. The scan lines G and the signal lines S are formed in the array substrate AR. Each scan line G is connected to the first gate driver GD1 and the second gate driver GD2. Each signal line S is connected to the selector SD.

In the example of FIG. 4, an area defined by scan lines G and signal lines S corresponds to one sub-pixel SPX. In the present embodiment, for example, a pixel PX is constituted by a sub-pixel SPXR corresponding to red, a sub-pixel SPXG corresponding to green and a sub-pixel SPXB corresponding to blue. The pixel PX may further comprise a sub-pixel SPX corresponding to white, etc.

Each sub-pixel SPX comprises a thin-film transistor TFT (switching element) formed in the array substrate AR. The thin-film transistor TFT is electrically connected to the scan line G, the signal line S and the pixel electrode PE. At the time of display, the drive electrodes TX are set at a common potential and function as so-called common electrodes.

The first gate driver GD1 and the second gate driver GD2 sequentially supply a scanning signal to the scan lines G. The selector SD selectively supplies a video signal to the respective signal lines S under the control of the driver IC 3. When a scanning signal is supplied to a scan line G connected to a certain thin-film transistor TFT and a video signal is supplied to a signal line S connected to the same thin-film transistor TFT, a voltage corresponding to the video signal is applied to the pixel electrode PE. At this time, an electrical field is produced between the pixel electrode PE and the drive electrode TX, which changes the alignment of the liquid crystal molecules in the liquid crystal layer LC from an initial alignment state where the voltage is not applied. Through the above-described operation, an image is displayed in the display area DA.

The display device 1 having the above-described structure may be a transmissive display device which displays an image using light from a backlight provided on the back surface (surface which is not opposed to the counter-substrate CT) of the array substrate AR, a reflective display device which displays an image using reflected external light which enters from the outer surface (surface which is not opposed to the array substrate AR) of the counter-substrate CT, or a display device which has the functions of both the transmissive display device and the reflective display device.

Next, the pixels PX and the detection electrodes RX will be described in detail.

FIG. 5 is a plan view showing an example of the pixels PX arrayed in the display area DA and the detection electrode RX overlapping the pixels PX. In the example illustrated, a red sub-pixel SPXR, a green sub-pixel SPXG and a blue subpixel SPXB which constitute a pixel PX are arranged in the first direction X in this order. The pixels PX are arranged in the first direction X and the second direction Y.

The detection electrode Rx is constituted by conductive lines CL. For example, the conductive lines CL have a single layer structure or a multilayer structure which includes a layer formed of at least one of the following metal materials: aluminum (Al), copper (Cu), silver (Ag), and an alloy thereof. The use of the metal material as the conductive lines CL makes it possible to reduce the resistance of the conductive lines CL as compared to the case of forming the conductive lines CL only of a transparent conductive material such as ITO.

More specifically, the detection electrode RX shown in FIG. 5 includes first conductive lines CL1 which are parallel to each other, and second conductive lines CL2 which are parallel to each other. The first conductive lines CL1 extend in a first extension direction D1 crossing the first direction X and the second direction Y. The second conductive lines CL2 extend in a second extension direction D2 crossing the first direction X, the second direction Y and the first extension direction D1. The first extension direction D1 is inclined with respect to the second direction Y at an acute angle θ1 in the clockwise direction. The second extension direction D2 is inclined with respect to the second direction Y at an acute angle θ2 in the counterclockwise direction. The first conductive lines CL1 and the second conductive lines CL2 cross each other to form a mesh-like pattern.

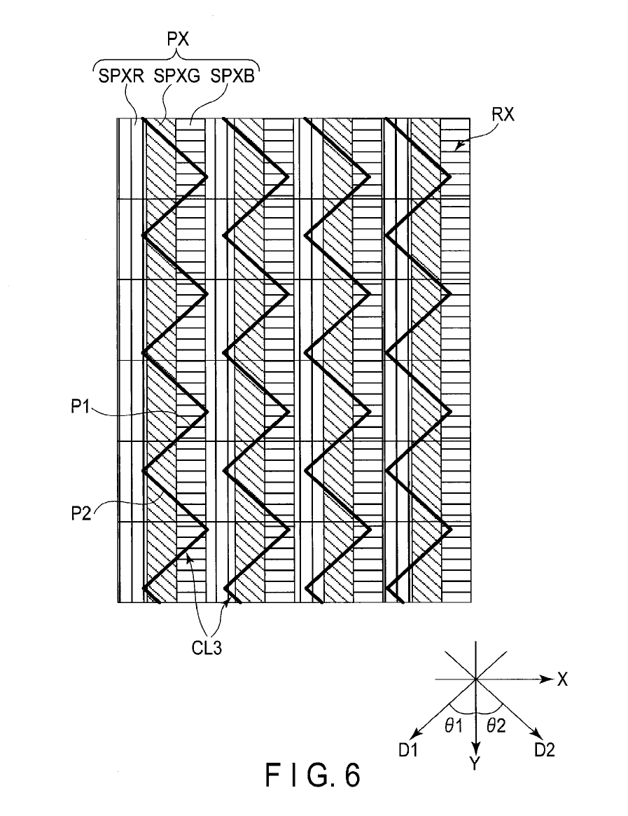

The pattern of the detection electrode RX is not limited to the example shown in FIG. 5 and various patterns can be adopted. FIG. 6 shows another example of the pattern of the detection electrode RX. The detection electrode RX shown in FIG. 6 includes conductive lines CL3 meandering in the second direction Y like waveforms. The conductive lines CL3 are arranged in the first direction X. The conductive lines CL3 forming one detection electrode RX are connected to each other at at least one end.

More specifically, the conductive lines CL3 shown in FIG. 6 are formed by connecting ends of first portions P1 extending in the first extension direction D1 to ends of second portions P2 extending in the second extension direction D2. In the same manner as the example of FIG. 5, the first extension direction D1 is inclined with respect to the second direction Y at angle θ1 in the clockwise direction, and the second extension direction D2 is inclined with respect to the second direction Y at angle θ2in the counterclockwise direction.

The conductive lines CL (CL1, CL2 and CL3) formed of the metal material have higher light-shielding effect than a transparent conductive film such as ITO. Accordingly, if the detection electrodes RX having the pattern shown in FIG. 5 or FIG. 6 overlap the regularly-arrayed pixels PX, the electrode pattern may cause optical interference with the pixel pattern. The pixel pattern includes a pattern formed by color differences between sub-pixels SPXR, SPXG and SPXB, and a pattern of the light-shielding layer 21 disposed in the boundaries between these sub-pixels. The interference between the pattern of the detection electrode RX and the pixel pattern is visually recognized as fringes (moiré) having lower frequency compared to the pixel pitch.

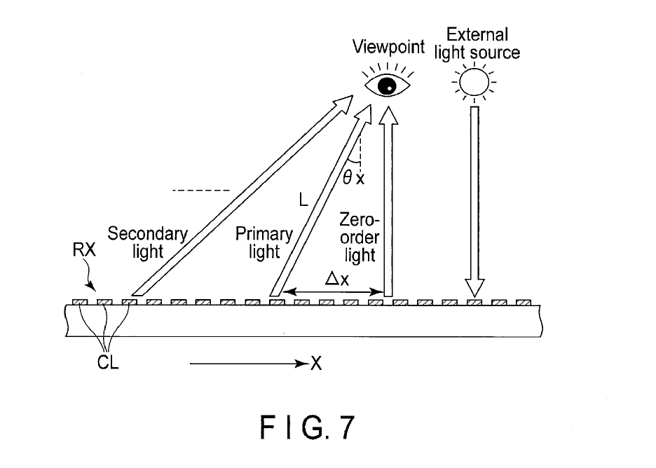

In addition, the conductive lines CL formed of the metal material may reflect external light, which may cause glare in the display area DA. The principle of occurrence of glare will be explained with reference to a model shown in FIG. 7. The model shows a relationship between a cross-section of the display panel 2 along the first direction X and a viewpoint of a user seeing the display area DA.

Part of light that enters from an external light source to the display panel 2 is reflected by the conductive lines CL of the detection electrodes RX. Glare occurs when the user sees diffracted light (primary light, secondary light, . . . ), not specular light (zero-order light). That is, glare seen at the viewpoint is caused by diffracted light from the pattern of the detection electrodes RX, i.e., part of a Fourier pattern obtained by performing a Fourier transform on the pattern.

As shown in FIG. 7, an observation angle of the diffracted light in the first direction X is defined as θx and a distance from a position of specular reflection on the conductive lines CL to a position of diffraction on the conductive lines CL in the first direction X is defined as Δx. The observation angle θx corresponds to an angle formed by the direction of the specular light and the direction of the diffracted light. In the same manner, an observation angle of the diffracted light in the second direction Y is defined as θy and a distance from a position of specular reflection on the conductive lines CL to a position of diffraction on the conductive lines CL in the second direction Y is defined as Δy. Further, a distance from the position of diffraction to the viewpoint (i.e., visual distance) is defined as L.

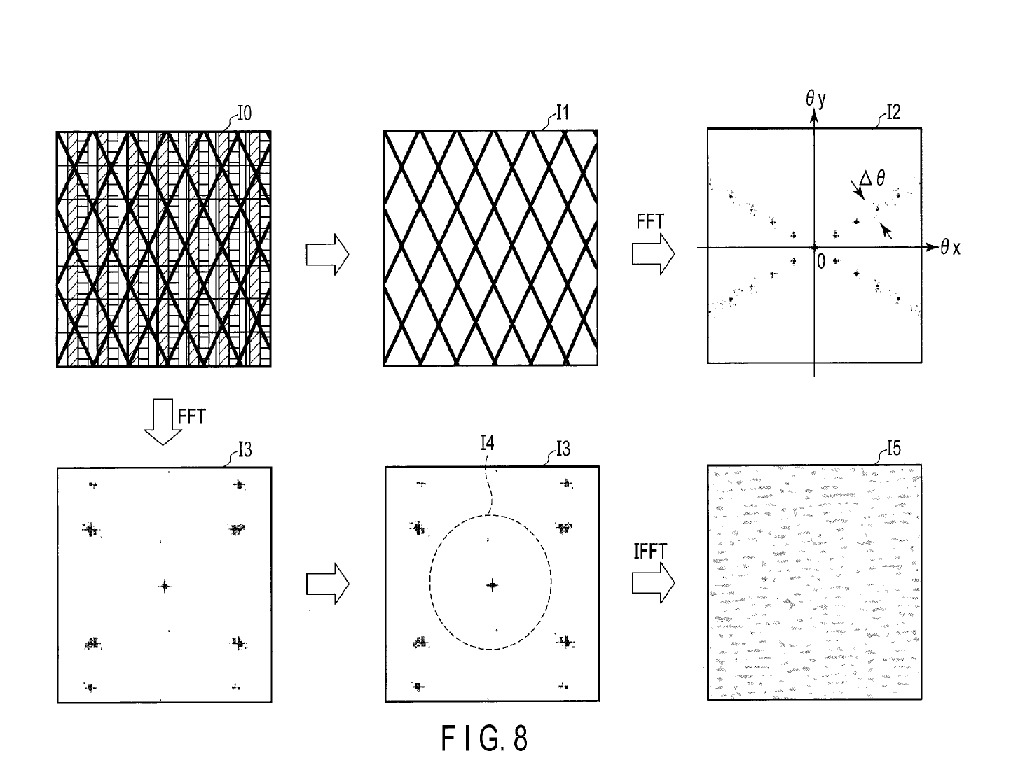

An example of methods for moiré and glare evaluation will be described with reference to FIG. 8. In FIG. 8, the upper half indicates a glare evaluation process and the lower half indicates a moiré evaluation process. In the glare evaluation, an electrode pattern image I1 indicative of a pattern of the detection electrode RX is first extracted from an actual image I0 of the display area DA. Next, a Fourier pattern I2 is generated by performing a Fourier transform (FFT) on the electrode pattern image I1.

The Fourier transform is performed to obtain distribution of diffracted light with respect to the observation angles θx and θy. For example, the Fourier pattern I2 indicates distribution of intensity of diffracted light in a plane in which the horizontal axis is the observation angle θx and the vertical axis is the observation angle θy. The Fourier pattern I2 corresponds to glare visually recognized by human eye. Therefore, glare caused by the detection electrodes RX can be evaluated based on the Fourier pattern I2.

In general, spectra along straight lines passing through the origin O (θx=0, θy=0) appear in the Fourier pattern I2. A width Δθ of the straight line spectrum can be used as one of indexes for glare evaluation. That is, glare increases as the width Δθ becomes larger and decreases as the width Δθ becomes smaller.

Considering a one-dimensional pattern in the first direction X, for example, in the case where the visual distance L shown in FIG. 7 is 10 cm, glare annoying to humans occurs if the distance Δx exceeds 1 mm. In this case, the allowable upper limit Δθmax of the width Δθ can be calculated as follows:

Δθmax=Δx/L=1 mm/100 mm*180/π≈0.6°

where π is the circular constant. In the case of using Δθmax obtained in this way, glare can be determined to be within the allowable range if Δθ<0.6.

In the moiré evaluation, a Fourier pattern I3 is generated by performing a gray scale transform on the actual image I0 which is a color image, and then performing a Fourier transform (FFT) on the image after the gray scale transform. The Fourier transform is performed to obtain distribution of a first spatial frequency in the first direction X and a second spatial frequency in the second direction Y. For example, the Fourier pattern I3 indicates distribution of frequency in a plane in which the horizontal axis is a first spatial frequency and the vertical axis is a second spatial frequency.

Next, a frequency domain I4 of a resolution visible to humans is extracted from the Fourier pattern I3. The visibility of humans depends on a contrast and a spatial frequency of an image. That is, the pattern tends to be more visible as the contrast and the spatial frequency of the pattern increases. For example, the frequency domain I4 can be extracted by filtering the Fourier pattern I3 by a contrast sensitivity function defined in consideration of the visibility.

After the frequency domain I4 is extracted, a moiré image I5 is generated by performing an inverse Fourier transform (IFFT) on the frequency domain I4. Fringes visible to humans appear in the moiré image I5. Therefore, the degree of moiré of the actual image I0 can be evaluated based on the moiré image I5. For example, the degree of moiré can be visibly determined. Alternatively, the degree of moiré can be determined by obtaining a standard deviation with respect to the moiré image I5 and determining whether the standard deviation belongs to a predetermined allowable range.

A specific operation method of the filtering using the contrast sensitivity function and the moiré evaluation using the standard deviation is disclosed in, for example, JP 2014-219973 A. The operation method disclosed in the literature can be arbitrarily used for the moiré evaluation explained with reference to FIG. 8.

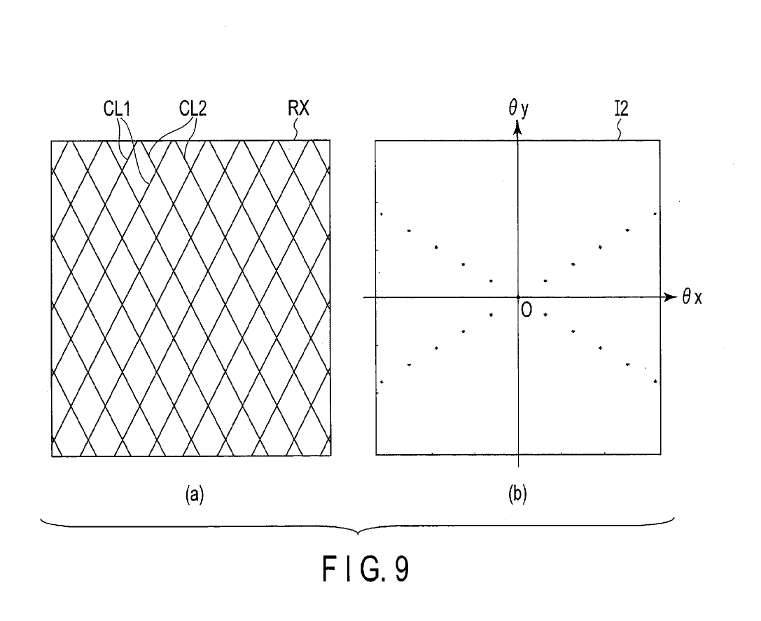

An example of evaluation in the above-described glare evaluation method is described. FIG. 9 is an illustration showing a mesh-like detection electrode RX and an example of glare evaluation thereof. As shown in the left side of FIG. 9, the detection electrode RX is constituted by first conductive lines CL1 arranged at regular pitch and second conductive lines CL2 arranged at regular pitch. The right side of FIG. 9 shows a Fourier pattern I2 generated by performing a Fourier transform on the pattern of the detection electrode RX.

Two groups of dots aligned like straight lines passing through the origin O appear in the Fourier pattern I2 of FIG. 9. In such a case where the spectrum appears as dots with almost no spread, visible glare is extremely low.

As explained above, glare is low in the detection electrode RX in which conductive lines CL are regularly arranged as shown in FIG. 9. If such a detection electrode RX overlaps a pixel pattern, however, moiré tends to occur. Since both the pattern of the detection electrode RX and the pixel pattern have regularity, low-frequency fringes tend to occur by the overlap.

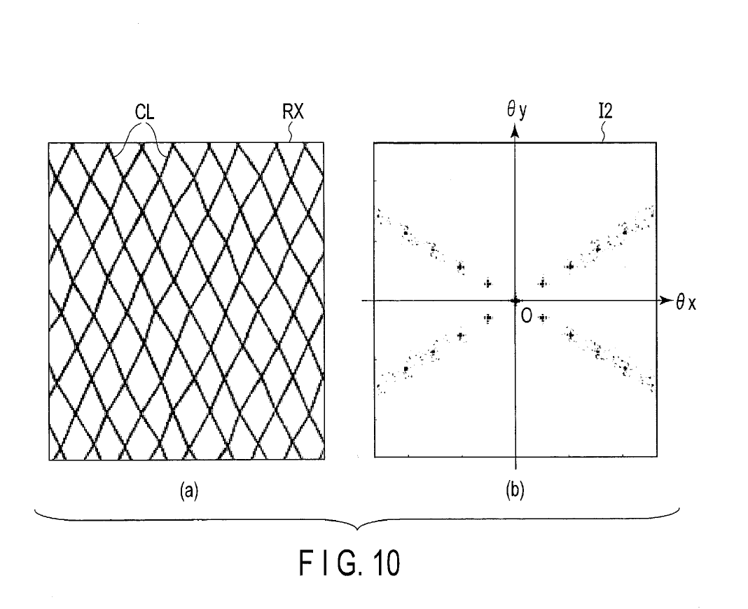

As a measure to avoid moiré, the regularity of the pattern of the detection electrode RX may be lessened. FIG. 10 shows an example of a detection electrode RX having a pattern of less regularity and glare evaluation thereof. The detection electrode RX shown in FIG. 10 is mesh-like in the same manner as FIG. 9, but apexes of a rectangular closed pattern (i.e., intersections of the conductive lines) are arranged at random positions. As a result, the pattern of detection electrode RX and the pixel pattern hardly interfere with each other and moiré is less prone to occur.

Two groups of dots aligned like straight lines passing through the origin O appear in a Fourier pattern I2 of the detection electrode RX of FIG. 10 in the same manner as FIG. 9, but spectra also appear around the groups of dots. For example, such spectra with spread have a width Δθ greater than Δθmax (≈0.6°) and are visually recognized as heavy glare.

As explained above, if the pattern of the detection electrode RX is designed to prevent moiré, there is a possibility that glare is increased. Therefore, the detection electrode RX should have a pattern that can prevent both moiré and glare.

In the following first to third embodiments, examples of a pattern of the detection electrode RX that can prevent moiré by having irregularity and also prevent glare.

### First Embodiment

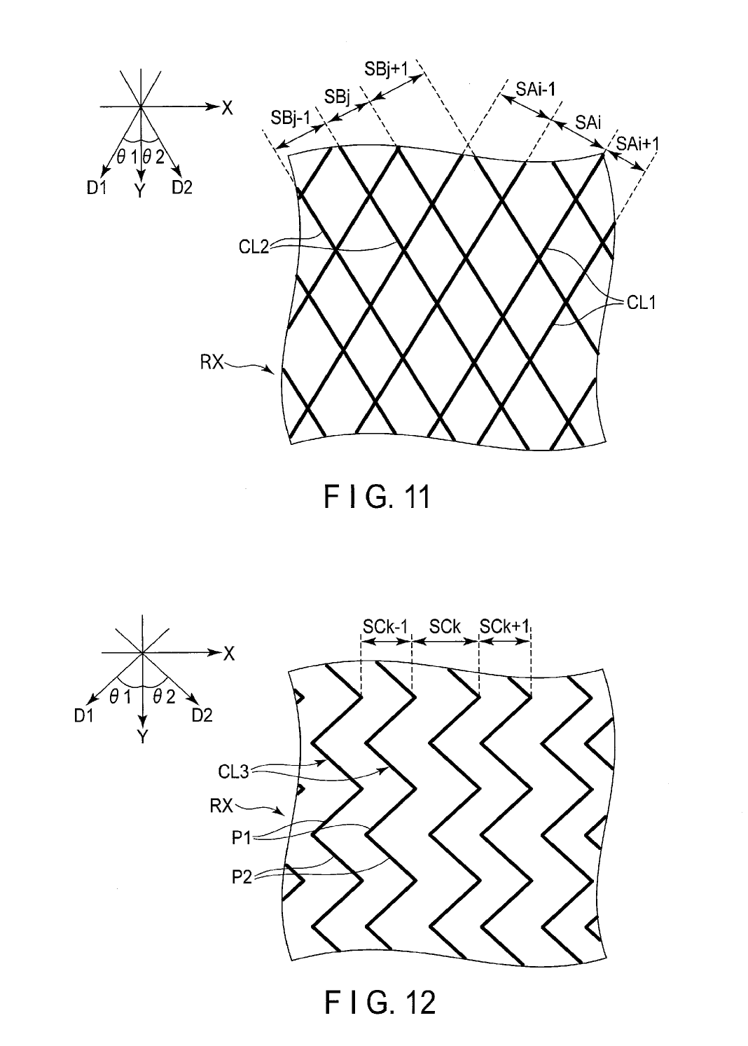

FIG. 11 is an illustration showing an example of a pattern of the detection electrode RX according to the first embodiment. The pattern is the same as the pattern of FIG. 5 in that conductive lines CL1 inclined with respect to the second direction Y at angle θ1 in the clockwise direction and second conductive lines CL2 inclined with respect to the second direction Y at angle θ2 in the counterclockwise direction cross each other like a mesh.

The degree of moiré changes according to angles 74 1 and θ2. In order to prevent moiré, for example, angles θ1 and θ2 should preferably be angles from 30 to 40° or from 50 to 60°. The line width of the first conductive lines CL1 and the second conductive lines CL2 is constant in FIG. 11, but may be changed according to positions.

In the present embodiment, the pattern of the detection electrode RX is provided with irregularity by randomizing pitch SA ( . . . SAi−1, SAi, SAi+1 . . . ) between adjacent first conductive lines CL1 and pitch SB ( . . . SBj−1, SBj, SBj+1 . . . ) between adjacent second conductive lines CL2.

For example, pitch SA and pitch SB are determined by the following equations:

SA=SA0±ΔSA (1)

SB=SB0±ΔSB (2)

where SA0 and SB0 are constant values, and ΔSA and ΔSB are deviations from constant values SA0 and SB0. Deviations ΔSA and ΔSB are, for example, random numbers. As a generation method of such random numbers, various methods such as a method using Fibonacci numbers may be adopted. Deviations ΔSA and ΔSB may be randomly selected from predetermined candidates.

If deviations ΔSA an ΔSB are too small, the pattern of the detection electrode RX cannot be provided with sufficient irregularity. If deviations ΔSA and ΔSB are too large, unevenness in density of conductive lines CL1 and CL2 in the detection electrode RX is increased, which may affect detection performance and result in nonuniformity in brightness of the display area DA. Therefore, deviations ΔSA and ΔSB should preferably satisfy the following equations:

0.01<ΔSA/SA0<0.1 (3)

0.01<ΔSB/SB0<0.1 (4)

For example, the dummy electrode DX shown in FIG. 1 has the same pattern as the detection electrode RX shown in FIG. 11. The dummy electrode DX may have a pattern in which the first conductive lines CL1 and the second conductive lines CL2 are broken at the intersections of the first conductive lines CL1 and the second conductive lines CL2. The dummy electrode DX can also be provided with irregularity by randomizing pitch SA and pitch SB.

The pattern of the detection electrode RX including wavy conductive lines CL3 shown in FIG. 6 can also be provided with irregularity by randomizing pitch of the conductive lines CL3. FIG. 12 is an illustration showing this modified example. In the same manner as FIG. 6, conductive lines CL3 alternately including first portions P1 and second portions P2 are arranged in the first direction X.

In the example of FIG. 12, the conductive lines CL3 are parallel to each other. The pattern of the detection electrode RX is provided with irregularity by randomizing pitch SC ( . . . SCk−1, SCk, SCk+1 . . . ) between the conductive lines CL3 adjacent to each other in the first direction X. Pitch SC can be randomized in the same way as pitch SA and pitch SB. The pattern of the detection electrode RX may be provided with irregularity by displacing the shapes of adjacent conductive lines CL3 in the second direction Y.

For example, the dummy electrode DX used together with the detection electrode RX of FIG. 12 has the same pattern as the detection electrode RX of FIG. 12. For example, the dummy electrode DX may have a pattern in which the conductive lines CL3 are broken at the ends of the first portions P1 and the second portions P2. Such a dummy electrode DX can also be provided with irregularity by randomizing pitch SC.

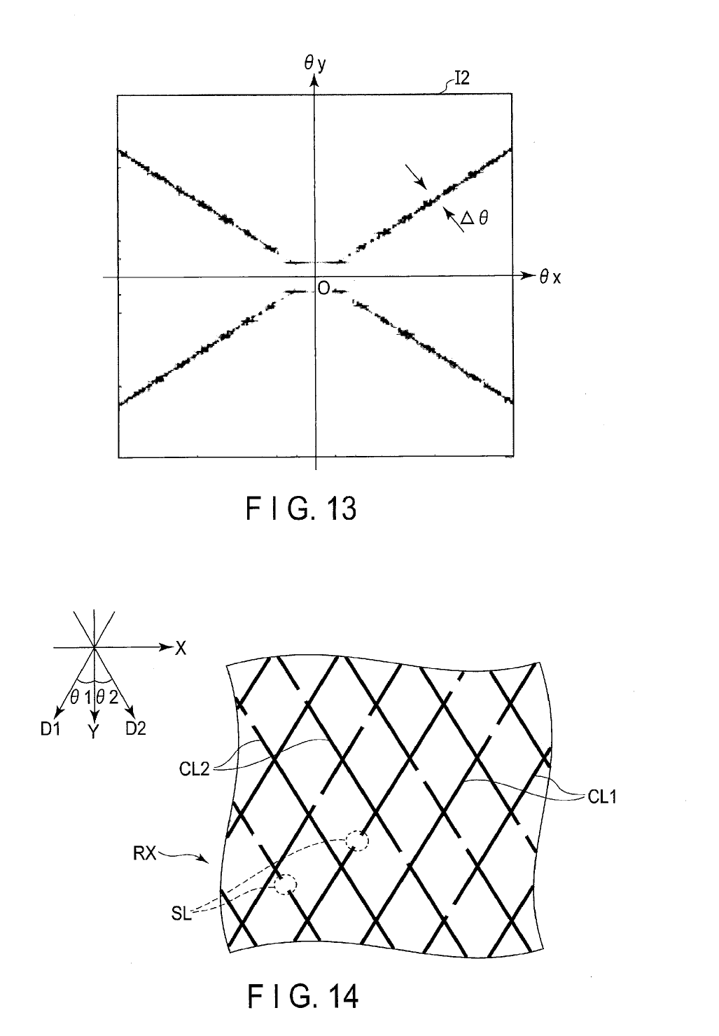

FIG. 13 shows a Fourier pattern I2 obtained by performing a Fourier transform on the pattern of the detection electrode RX shown in FIG. 11. The Fourier pattern I2 includes spectra extending linearly from the vicinity of the origin O in a direction in which θx and θy are positive, a direction in which θx and θy are negative, a direction in which θx is positive and θy is negative and a direction in which θx is negative and θy is positive, respectively. In the pattern of the detection electrode RX of FIG. 11, the intersections of the first conductive lines CL1 and the second conductive lines CL2 are aligned linearly in the first conductive lines CL1 or the second conductive lines CL2. In this case, the width Δθ of each straight line spectrum included in the Fourier pattern I2 is smaller than that in the case of randomizing positions of the intersections of the conductive lines as shown in FIG. 10. For example, the width Δθ of each straight line spectrum is less than Δθmax (≈0.6°) and visible glare is low. Straight line spectra also appear in a Fourier pattern I2 of the detection electrode RX shown in FIG. 12, but the width Δθ is small and glare is low.

Since the patterns of the detection electrode RX shown in FIG. 11 and FIG. 12 have irregularity, moiré caused by interference with the pixel pattern can be avoided.

### Second Embodiment

FIG. 14 is an illustration showing an example of a pattern of the detection electrode RX according to the second embodiment. The pattern is the same as the pattern of FIG. 5 in that conductive lines CL1 inclined with respect to the second direction Y at angle θ1 in the clockwise direction and second conductive lines CL2 inclined with respect to the second direction Y at angle θ2 in the counterclockwise direction cross each other like a mesh.

In the same manner as the first embodiment, angles θ1 and θ2 should preferably be angles from 30 to 40° or from 50 to 60°. The line width of the first conductive lines CL1 and the second conductive lines CL2 is constant in FIG. 14, but may be changed according to positions. For example, pitch of the first conductive lines CL1 and pitch of the second conductive lines CL2 are constant, but may be changed in the same manner as the first embodiment.

In the present embodiment, the pattern of the detection electrode RX is provided with irregularity by providing slits SL in the first conductive lines CL1 and the second conductive lines CL2. The slits SL are provided at random positions. The specific positions of the slits SL can be determined based on random numbers generated by using, for example, Fibonacci numbers. The slits SL may be provided only in the first conductive lines CL1 or only in the second conductive lines CL2.

If an electrically floating portion is generated in the pattern of the detection electrode RX by providing the slits SL, the portion does not contribute to detection of an object, which may result in a decrease in detection performance. In addition, if the slits SL are concentrated in a certain position, the light transmittance in this position increases, which may result in nonuniformity in brightness of the display area DA. Therefore, the density and the positions of the slits SL may be adjusted so as to avoid the generation of the electrically floating portion and the nonuniformity in brightness.

If the slits SL are provided at the intersections of the first conductive lines CL1 and the second conductive lines CL2, current paths are greatly reduced in the pattern of the detection electrode RX, which may result in high resistance of the detection electrode RX. Thus, in the example of FIG. 14, the slits SL are provided at positions other than the intersections of the first conductive lines CL1 and the second conductive lines CL2.

The dummy electrode DX shown in FIG. 1 can also be provided with irregularity by providing the slits SL at random positions.

The pattern of the detection electrode RX can be provided with irregularity by the slits SL of the present embodiment. As a result, moiré caused by interference with the pixel pattern can be prevented. In addition, the slits SL are provided along the first conductive lines CL1 or the second conductive lines CL2 and regularity of the intersections of the conductive lines CL1 and CL2 is maintained. In this case, the Fourier pattern I2 of the detection electrode RX includes straight line spectra having small width Δθ in the same manner as FIG. 13. Therefore, glare can also be reduced.

In the case of the detection electrode RX including wavy conductive lines CL3 shown in FIG. 6, an electrically floating portion is generated in the conductive lines CL3 if the slits SL are provided. For this reason, the slits SL cannot be provided in the conductive lines CL3 of the detection electrode RX, but can be provided in conductive lines CL3 of the dummy electrode DX.

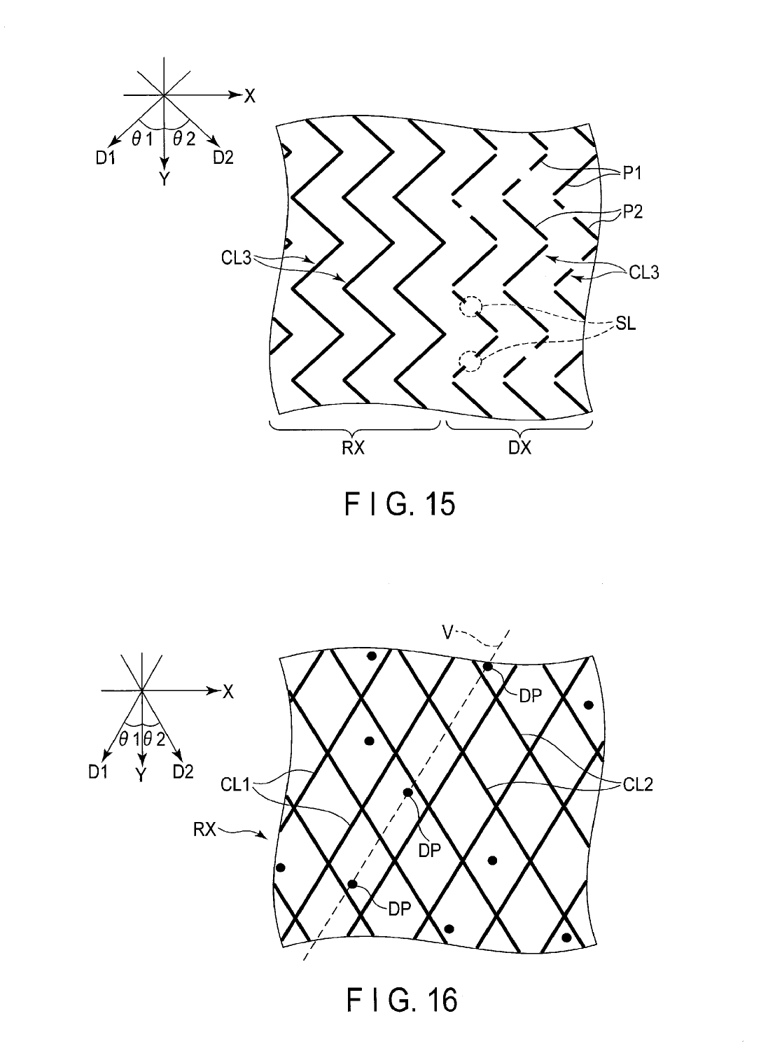

FIG. 15 is an illustration of this modified example and shows part of the detection electrode RX and part of the dummy electrode DX adjacent to the detection electrode RX. In the dummy electrode DX, the conductive lines CL3 are broken at the ends of the first portions P1 and the second portions P2. In addition, slits SL are provided at random positions in the conductive lines CL3 of the dummy electrode DX. Alternatively, the dummy electrode DX may be configured such that the ends of the first portions P1 and the second portions P2 are connected and the slits SL are provided at random positions.

### Third Embodiment

FIG. 16 is an illustration showing an example of a pattern of the detection electrode RX according to the third embodiment. The pattern of the detection electrode RX is the same as the pattern of FIG. 5 in that conductive lines CL1 inclined with respect to the second direction Y at angle θ1 in the clockwise direction and second conductive lines CL2 inclined with respect to the second direction Y at angle θ2 in the counterclockwise direction cross each other like a mesh.

In the same manner as the first embodiment, angles θ1 and θ2 should preferably be angles from 30 to 40° or from 50 to 60°. The line width of the first conductive lines CL1 and the second conductive lines CL2 is constant in FIG. 15, but may be changed according to positions. For example, pitch of the first conductive lines CL1 and pitch of the second conductive lines CL2 are constant, but may be changed in the same manner as the first embodiment.

In the present embodiment, the pattern of the detection electrode RX is provided with irregularity by providing dummy patterns DP in addition to the first conductive lines CL1 and the second conductive lines CL2. Each dummy pattern DP is arranged in a rectangular closed pattern formed by two first conductive lines CL1 and two second conductive lines CL2, and is not electrically connected to the first conductive lines CL1 and the second conductive lines CL2. The dummy patterns DP are formed of a metal material similarly to the conductive lines CL1 and CL2, and exhibit the same degree of light-shielding effect as the conductive lines CL1 and CL2. For example, the shape of the dummy patterns DP is a circle having a diameter substantially equal to the width of the conductive lines CL1 and CL2, but may be a circle having a diameter greater or less than the width of the conductive lines CL1 and CL2 or may be other shapes such as an ellipse or a rectangle.

For example, the dummy patterns DP are arranged at random positions in a virtual line V. The virtual line V is a straight line extending between two first conductive lines CL1 and parallel to the first extension direction D1. The specific positions of the dummy patterns DP in the virtual line V can be determined based on random numbers generated by using, for example, Fibonacci numbers. Alternatively, the dummy patterns DP may be arranged at random positions in a virtual line parallel to the second extension direction D2 of the second conductive lines CL2. The dummy electrode DX can be provided with irregularity by randomly arranging the dummy patterns DP.

The dummy patterns DP may be randomly arranged in the virtual line V so as to overlap sub-pixels SPX of a particular color. The particular color is, for example, a color possessing the maximum luminosity for human eye, of the colors of the sub-pixels SPX included in the pixel PX. Among red, green, and blue, the color possessing maximum luminosity for human eye is green. Thus, if the pixel PX is constituted by a red sub-pixel SPXR, a green sub-pixel SPXG and a blue sub-pixel SPXB, the dummy patterns DP are arranged to overlap the green sub-pixels SPXG.

The sub-pixels SPX of the color possessing high luminosity tend to cause moiré. Therefore, if the dummy patterns DP are arranged to overlap the sub-pixels SPX of the color possessing the maximum luminosity, the overlap between the sub-pixels SPX of the color and the detection electrodes RX becomes irregular and moiré can be efficiently reduced.

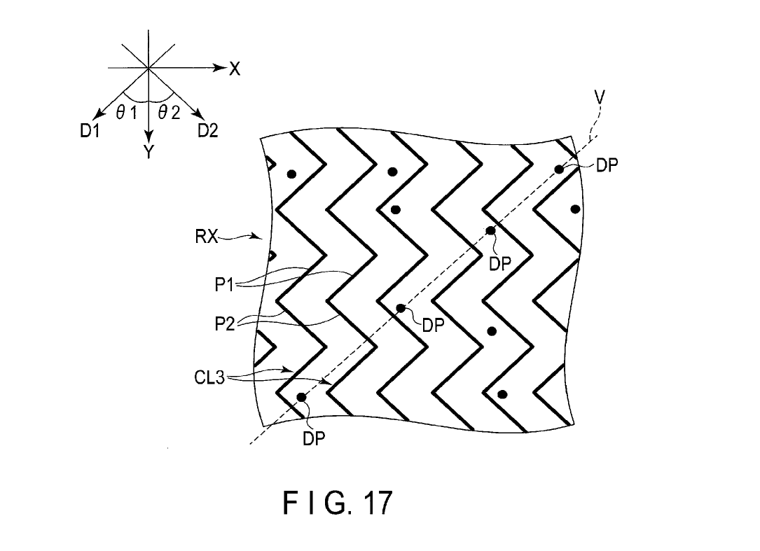

The pattern of the detection electrode RX including wavy conductive lines CL3 shown in FIG. 6 can also be provided with irregularity by randomizing pitch of the conductive lines CL3. FIG. 17 is an illustration showing this modified example. In the same manner as FIG. 6, conductive lines CL3 alternately including first portions P1 and second portions P2 are arranged in the first direction X.

In the example of FIG. 17, the dummy patterns DP are arranged at random positions in a virtual line V parallel to the first extension direction D1. However, the dummy patterns DP may be arranged at random positions in a virtual line parallel to the second extension direction D2. The dummy electrode DX used together with the detection electrode RX of FIG. 17 can also be provided with irregularity by randomly arranging the dummy patterns DP.

The pattern of the detection electrode RX can be provided with irregularity by providing the dummy patterns DP as in the present embodiment. As a result, moiré caused by interference with the pixel pattern can be prevented. In addition, the dummy patterns DP are arranged in the virtual line V parallel to the first extension direction D1 or the second extension direction D2, and regularity of the intersections of the conductive lines CL1 and CL2 (or connecting points between the first portions P1 and the second portions P2) is maintained. In this case, the Fourier pattern I2 of the detection electrode RX includes straight line spectra having small width Δθ in the same manner as FIG. 13. Therefore, glare can also be reduced.

While certain embodiments have been described, these embodiments have been presented by way of example only, and are not intended to limit the scope of the inventions. These novel embodiments can be carried out in various other modes, in which various omissions, substitutions and variations may be carried out within the scope and spirit of the technology. Such changes and modifications are encompassed by the scope and spirit of the technology, and naturally fall within the scope and its equivalency of the technology recited in the claims.

For example, each embodiment shows a mesh-like detection electrode RX constituted by first conductive lines CL1 and second conductive lines CL2 and a detection electrode RX constituted by conductive lines CL3 meandering like waveforms. However, various other patterns can be adopted as the detection electrode RX. For example, the detection electrode RX may include a polygonal closed pattern formed by conductive lines and other than a rectangle, or may include curved conductive lines.

The pattern of the detection electrode RX may be provided with irregularity by a method other than randomizing pitch of the conductive lines, providing slits at random positions in the conductive lines and providing dummy patterns at random positions. In this case, too, both moiré and glare can be reduced if the pattern of the detection electrode RX is designed such that the width Δθ of a straight line spectrum is less than about 0.6° in a Fourier pattern I2 obtained by performing a Fourier transform on the pattern of the detection electrode RX.

In each embodiment, the drive electrode TX is used for object detection as well as for image display. However, an electrode for object detection and an electrode for image display may be separately provided instead. In that case, for example, the touch sensing device may be configured by forming the drive electrodes TX on one main surface of a transparent substrate such as a glass substrate, and forming the detection electrodes RX on the other main surface of the substrate.

In each embodiment, a mutual-capacitive method of detecting an object by the detection electrode RX and the drive electrode TX is described. However, the object detection method may be other methods such as a method of detecting an object by using the capacitance of the detection electrode RX itself (referred to as a self-capacitance detection method or the like).

The technical thoughts disclosed in the embodiments can be arbitrarily combined. That is, the detection electrode RX may be configured by adopting two or three of the following methods: a method of randomizing pitch of the conductive lines; a method of providing slits at random positions in the conductive lines; and a method of providing dummy patterns at random positions.

What is claimed is:

1. A display device comprising:
pixel electrodes provided for respective pixels arrayed in a display area;
a drive electrode which forms an electric field for image display with the pixel electrodes;
a detection electrode opposed to the drive electrode; and
a detection module which detects an object in proximity to the display area based on a signal obtained from the detection electrode,
wherein the detection electrode includes conductive lines extending parallel to each other, and
the conductive lines are arranged at randomized pitch.

2. The display device of claim 1, wherein
the pitch S of the conductive lines is expressed as S=S0±ΔS, where S0is a constant value and ΔS is a deviation, and
the deviation ΔS is a random number that satisfies 0. 01<ΔS/S0<0.1.

3. The display device of claim 1, wherein
a straight line spectrum having a width less than 0.6° is included in a Fourier pattern obtained by performing a Fourier transform on a pattern of the detection electrode with respect to an observation angle in a first direction and an observation angle in a second direction orthogonal to the first direction.

4. A display device comprising:
pixel electrodes provided for respective pixels arrayed in a display area;
a drive electrode which forms an electric field for image display with the pixel electrodes;
a detection electrode opposed to the drive electrode; and
a detection module which detects an object in proximity to the display area based on a signal obtained from the detection electrode,
wherein the detection electrode includes conductive lines extending parallel to each other, and
slits are provided in random positions in the conductive lines.

5. The display device of claim 4, wherein
the detection electrode includes:
first conductive lines extending in a first extension direction and arranged in parallel to each other; and
second conductive lines extending in a second extension direction crossing the first extension direction and arranged in parallel to each other,
the detection electrode has a mesh-like pattern in which the first conductive lines and the second conductive lines cross each other, and
the slits are provided in the random positions except intersections of the first conductive lines and the second conductive lines in at least one of the first conductive lines and the second conductive lines.

6. The display device of claim 4, wherein
a straight line spectrum having a width less than 0.6° is included in a Fourier pattern obtained by performing a Fourier transform on a pattern of the detection electrode with respect to an observation angle in a first direction and an observation angle in a second direction orthogonal to the first direction.

7. A display device comprising:
pixel electrodes provided for respective pixels arrayed in a display area;
a drive electrode which forms an electric field for image display with the pixel electrodes;
a detection electrode opposed to the drive electrode; and
a detection module which detects an object in proximity to the display area based on a signal obtained from the detection electrode,
wherein the detection electrode includes:
conductive lines extending parallel to each other; and
dummy patterns arranged in random positions between the conductive lines and electrically unconnected to the conductive lines.

8. The display device of claim 7, wherein
each of the pixels includes sub-pixels corresponding to different colors, and
the dummy patterns are arranged in positions overlapping sub-pixels corresponding to a particular color of the sub-pixels.

9. The display device of claim 7, wherein
a straight line spectrum having a width less than 0.6° is included in a Fourier pattern obtained by performing a Fourier transform on a pattern of the detection electrode with respect to an observation angle in a first direction and an observation angle in a second direction orthogonal to the first direction.
